(19) United States
(12) Patent Application Publication
(10) Pub. No.: US 2014/0310039 A1
(43) Pub. Date: Oct. 16, 2014

(54) Automated Cloud Expansion and Ordering System and Method

(71) Applicant: CenturyLink Intellectual Property LLC, Denver, CO (US)

(72) Inventors: Steven M. Casey, Littleton, CO (US); Felipe Castro, Erie, CO (US); Kevin M. McBride, Lone Tree, CO (US)

(73) Assignee: CenturyLink Intellectual Property LLC, Denver, CO (US)

(21) Appl. No.: 14/107,323

(22) Filed: Dec. 16, 2013

Related U.S. Application Data
(60) Provisional application No. 61/812,516, filed on Apr. 16, 2013.

(51) Int. Cl. G06Q 30/06

(52) U.S. Cl. CPC G06Q 30/0635
USPC 705/7.13

(57) ABSTRACT

Novel tools and techniques are provided for implementing automated cloud expansion and ordering. Implementing automated cloud expansion and ordering might include monitoring cloud services and hardware operated by a cloud service provide. In some cases, monitoring may be periodically performed, while in other cases monitoring may be triggered by ordering of new cloud services by a subscriber. Based on a determination that hardware utilization is likely to exceed a predetermined threshold amount, the system might determine a number and type of new equipment, and to automatically generate and send purchase orders to vendor(s) for the new equipment. The system may also send work orders to technicians that include the site location, rack and slot identifiers, estimated equipment delivery dates and times, or the like. The system might also remotely (over a network) install software (including operating systems, software applications, and configuration files) on the new equipment.

### CROSS-REFERENCES TO RELATED APPLICATIONS

This application claims priority to U.S. Patent Application Ser. No. 61/812,516 (the “'516 application”), filed Apr. 16, 2013 by Steven M. Casey et al. (attorney docket no. 020370-011301US), entitled, “Automated Cloud Expansion and Ordering System and Method,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, apparatus, and computer software for implementing automated cloud expansion and ordering.

### BACKGROUND

Today, cloud systems use manual processes for ordering, provisioning, and installing new cloud equipment. As a result, such cloud systems require many different backend systems to understand where new equipment needs to be installed and configured. This makes it difficult to understand where new equipment needs to be installed and configured when it arrives on site.

Hence, there is a need for more robust and scalable cloud expansion solutions.

### BRIEF SUMMARY

Various embodiments provide techniques for implementing automated cloud expansion and automated ordering of hardware to support expanded cloud services.

According to some embodiments, a system might provide a method for monitoring the cloud (particularly, the cloud services and hardware operated by a cloud service provider) and automatically ordering and provisioning new resources as they are needed. The system might manage the tracking of the cloud's needs, from the customer ordering resources, to the fulfillment of those resources through the supply chain, ordering, shipping, delivery, installation, provisioning, turn up, and orchestration. Herein, the term “turn up” might refer to provisioning the hardware (or hardware resources) to and/or for the customer(s), once the hardware has been installed.

The tools provided by various embodiments include, without limitation, methods, systems, and/or software products. Merely by way of example, a method might comprise one or more procedures, any or all of which might be executed by a computer system. Correspondingly, an embodiment might provide a computer system configured with instructions to perform one or more procedures in accordance with methods provided by various other embodiments. Similarly, a computer program might comprise a set of instructions that are executable by a computer system, or by a processor located in the computer system, to perform such operations. In many cases, such software programs are encoded on physical, tangible, and/or non-transitory computer readable media. Such computer readable media might include, to name but a few examples, optical media, magnetic media, and the like.

In an aspect, a method might be provided for implementing automated cloud expansion and ordering. The method might comprise receiving, at a server associated with a cloud service provider and over a network, an order from a subscriber for new cloud services; monitoring, by the server, status and use of each of a plurality of hardware associated with cloud services provided by the cloud service provider; and determining, by the server, whether addition of the new cloud services ordered by the subscriber is likely to cause utilization of the plurality of hardware to exceed a predetermined threshold. Based on a determination that addition of the new cloud services ordered by the subscriber is likely to cause utilization of the plurality of hardware to exceed a predetermined threshold, the method might further comprise determining, by the server, a number of new equipment and a type of each of the new equipment to purchase in order to ensure that the cloud services including the new cloud services does not cause utilization of a combination of the plurality of hardware and the new equipment to exceed the predetermined threshold.

The method might also comprise generating, by the server, one or more purchase orders for the new equipment to be sent to one or more equipment vendors, based on the determined number of new equipment and the type of each of the new equipment. The method might further comprise determining, by the server, geographic location information, rack information, and slot information for installation of each of the new equipment; adding, by the server, the determined geographic location information, rack information, and slot information for each of the new equipment in the one or more purchase orders; and sending, by the server, the one or more purchase orders to the one or more equipment vendors. The method might comprise receiving, by the server, equipment information and shipment tracking information from each of the one or more equipment vendors; generating, by the server, a first set of work orders comprising equipment information, shipment tracking information, geographic location information, rack information, and slot information for each of the new equipment; and sending, by the server, the first set of work orders to one or more technicians for installing each of the new equipment at the determined geographic location corresponding to the subject new equipment.

The method might further comprise determining, by the server, one or more software applications for installation on each of the new equipment, and based on a determination that one or more of the new equipment have been installed by the one or more technicians and that the one or more of the new equipment are accessible over the network, installing, by the server and over the network, the one or more software applications on each of the one or more of the new equipment. Based on a determination that at least one of the new equipment has been installed by the one or more technicians and that the at least one of the new equipment is inaccessible over the network, the method might comprise sending, by the server and over the network, the one or more software applications for each of the at least one of the new equipment to the one or more technicians and sending a second set of work orders to the one or more technicians to manually install the one or more software applications on each of the at least one of the new equipment.

In another aspect, an alternative method might be provided for implementing automated cloud expansion and ordering. The method might comprise monitoring, by a server associated with a cloud service provider, status and use of each of a plurality of hardware associated with cloud services provided by the cloud service provider, and determining, by the server, whether utilization of the plurality of hardware is likely to exceed a predetermined threshold, based on one of a trend of the monitored status and use of each of the plurality of hardware or information related to new orders for cloud services by subscribers. The method might further comprise, based on a determination that utilization of the plurality of hardware is likely to exceed a predetermined threshold, determining, by the server, a number of new equipment and a type of each of the new equipment to purchase in order to ensure that utilization of a combination of the plurality of hardware and the new equipment does not exceed the predetermined threshold. The method might also comprise generating, by the server, one or more purchase orders for the new equipment to be sent to one or more equipment vendors, based on the determined number of new equipment and the type of each of the new equipment. The method might further comprise determining, by the server, location information for installation of each of the new equipment, adding, by the server, the determined location information in the one or more purchase orders, and sending, by the server, the one or more purchase orders to the one or more equipment vendors.

In some embodiments, the method might further comprise receiving, by the server over a network, an order from a subscriber for new cloud services. In some cases, the method might also comprise determining, by the server, whether commitments by the cloud service provider to at least one of the subscriber or existing customers will likely be met, and, based on a determination that commitments to the at least one of the subscriber or the existing customers will likely not be met, escalating, by the server, steps for ordering and installing the new equipment.

According to some embodiments, each of the location information might comprise geographic location information, rack information, and slot information corresponding to installation of each of the new equipment, and the method might further comprise receiving, by the server, equipment information and shipment tracking information from each of the one or more equipment vendors. The method might also comprise generating, by the server, a first set of work orders comprising equipment information, shipment tracking information, geographic location information, rack information, and slot information for each of the new equipment, and sending, by the server, the first set of work orders to one or more technicians for installing each of the new equipment at the determined geographic location corresponding to the subject new equipment.

In some cases, the method might further comprise receiving, by the server, a status update comprising at least one of a notification that the new equipment has been ordered, a notification regarding availability of the new equipment by the one or more equipment vendors, one or more shipping dates of the new equipment, one or more received dates of the new equipment, or one or more installation dates of the new equipment. The method might also comprise, based on a determination that a first hardware among the new equipment is unavailable from a first vendor of the one or more equipment vendors, sending, by the server, an additional purchase order for the first hardware to a second vendor of the one or more equipment vendors.

In yet another aspect, an apparatus might be provided for implementing automated cloud expansion and ordering. The apparatus might comprise one or more processors and one or more non-transitory computer readable media. The one or more non-transitory computer readable media might have stored thereon software comprising a set of instructions that, when executed by the one or more processors, causes the apparatus to perform one or more functions. The set of instructions might comprise instructions to monitor status and use of each of a plurality of hardware associated with cloud services provided by a cloud service provider, and instructions to determine whether utilization of the plurality of hardware is likely to exceed a predetermined threshold, based on one of a trend of the monitored status and use of each of the plurality of hardware or information related to new orders for cloud services by subscribers. The set of instructions might further comprise instructions to determine, based on a determination that utilization of the plurality of hardware is likely to exceed a predetermined threshold, a number of new equipment and a type of each of the new equipment to purchase in order to ensure that utilization of a combination of the plurality of hardware and the new equipment does not exceed the predetermined threshold. The set of instructions might also comprise instructions to generate one or more purchase orders for the new equipment to be sent to one or more equipment vendors, based on the determined number of new equipment and the type of each of the new equipment. The set of instructions might further comprise instructions to determine location information for installation of each of the new equipment, instructions to add the determined location information in the one or more purchase orders, and instructions to send the one or more purchase orders to the one or more equipment vendors.

In some embodiments, the new equipment might include cloud service equipment selected from a group consisting of servers, blade servers, data storage devices, network devices, cooling systems, and equipment racks.

In still another aspect, a system might be provided for implementing automated cloud expansion and ordering. The system might comprise a utilization monitoring system, a cloud orchestration system, and an automated provisioning system.

The utilization monitoring system might comprise one or more utilization monitoring devices configured to monitor status and use of each of a plurality of hardware associated with cloud services provided by a cloud service provider. The one or more utilization monitoring devices might be further configured to determine whether utilization of the plurality of hardware is likely to exceed a predetermined threshold, based on one of a trend of the monitored status and use of each of the plurality of hardware or information related to new orders for cloud services by subscribers. The cloud orchestration system might comprise one or more first processors configured to, based on a determination that utilization of the plurality of hardware is likely to exceed a predetermined threshold, determine a number of new equipment and a type of each of the new equipment to purchase in order to ensure that utilization of a combination of the plurality of hardware and the new equipment does not exceed the predetermined threshold. The one or more first processors might be further configured to determine location information for installation of each of the new equipment. The automated provisioning system might comprise one or more second processors configured to generate one or more purchase orders for the new equipment to be sent to one or more equipment vendors, based on the determined number of new equipment and the type of each of the new equipment. The one or more second processors might be further configured to add the determined location information in the one or more purchase orders, and to send the one or more purchase orders to the one or more equipment vendors.

In some embodiments, the system might further comprise an automated subscriber interface system comprising one or more third processors configured to receive, over a network, an order from a subscriber for new cloud services. In some instances, each of the location information might comprise geographic location information, rack information, and slot information corresponding to installation of each of the new equipment.

In some cases, the one or more second processors of the automated provisioning system might be further configured to receive equipment information and shipment tracking information from each of the one or more equipment vendors. The one or more first processors of the cloud orchestration system might be further configured to generate a first set of work orders comprising equipment information, shipment tracking information, geographic location information, rack information, and slot information for each of the new equipment. The one or more first processors of the cloud orchestration system might also be configured to send the first set of work orders to one or more technicians for installing each of the new equipment at the determined geographic location corresponding to the subject new equipment.

Various modifications and additions can be made to the embodiments discussed without departing from the scope of the invention. For example, while the embodiments described above refer to particular features, the scope of this invention also included embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIGS. 1 and 2 are general schematic diagrams illustrating a system for implementing automated cloud expansion and ordering, in accordance with various embodiments.

FIGS. 3-5 are general schematic flow diagrams illustrating methods for implementing automated cloud expansion and ordering, in accordance with various embodiments.

FIG. 6 is a block diagram illustrating an exemplary computer architecture, in accordance with various embodiments.

FIG. 7 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments provide techniques for implementing automated cloud expansion and automated ordering of hardware to support expanded cloud services.

According to some embodiments, a system might provide a method for monitoring the cloud (particularly, the cloud services and hardware operated by a cloud service provider) and automatically ordering and provisioning new resources as they are needed. The system might manage the tracking of the cloud's needs from the customer ordering resources to the fulfillment of those resources through the supply chain, ordering, shipping, delivery, installation, provisioning, turn up, and orchestration. Herein, the term “turn up” might refer to, once hardware has been installed, provisioning the hardware (or hardware resources) to and/or for the customer(s).

In some instances, in response to a customer ordering a set of cloud services (including, but not limited to, virtual machines on which to run a database and/or a web server), either from a cloud storefront, via telephone, or via a website of a cloud service provider, the cloud automation system might check available resources to determine whether these resources can fulfill the request for the set of cloud services. If the system determines that it does not have the needed resources, then the system might automatically place an order to its equipment provider for the needed hardware and software. The equipment provider would return the equipment information and shipment tracking information to the system. The system might also inform the equipment provider as to whether to ship the equipment for installation. A notice might be sent to the installers when the equipment is expected to arrive so an installer would be on-site for the install. Once the equipment has been installed, the cloud system might automatically match it to the equipment identification (“ID”) and install the needed software (including, without limitation, operating system(s), necessary software applications, system configurations, and/or server/network configurations, etc.). The cloud might then orchestrate the necessary provisioning for what the customer ordered. The services might be setup to meet the needs of the order.

In some cases, the system might also be set up to maintain minimum services availability levels based on threshold levels or past trending information. For example, a threshold level might be set so that 40% of the hardware resources are always available. When the availability levels drop below the threshold levels, the system might automatically order new equipment for the resource pool.

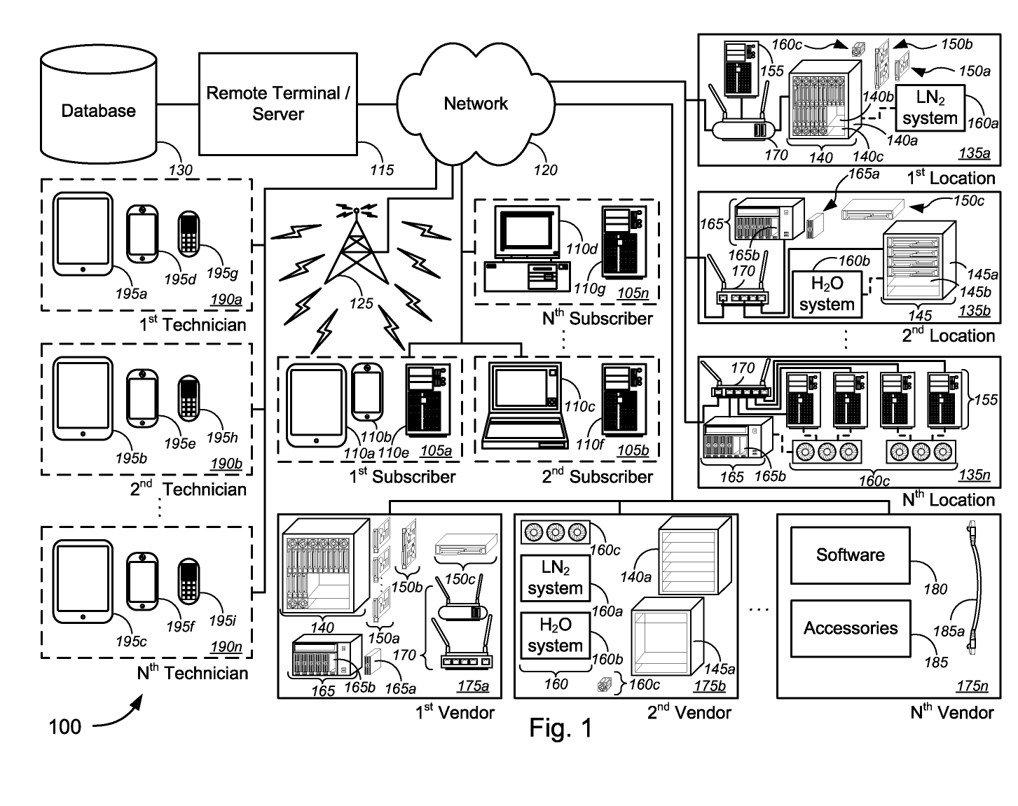

We now turn to the embodiments as illustrated by the drawings. FIGS. 1-7 illustrate some of the features of the method, system, and apparatus for implementing automated cloud expansion and automated ordering of hardware to support expanded cloud services, as referred to above. The methods, systems, and apparatuses illustrated by FIGS. 1-7 refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

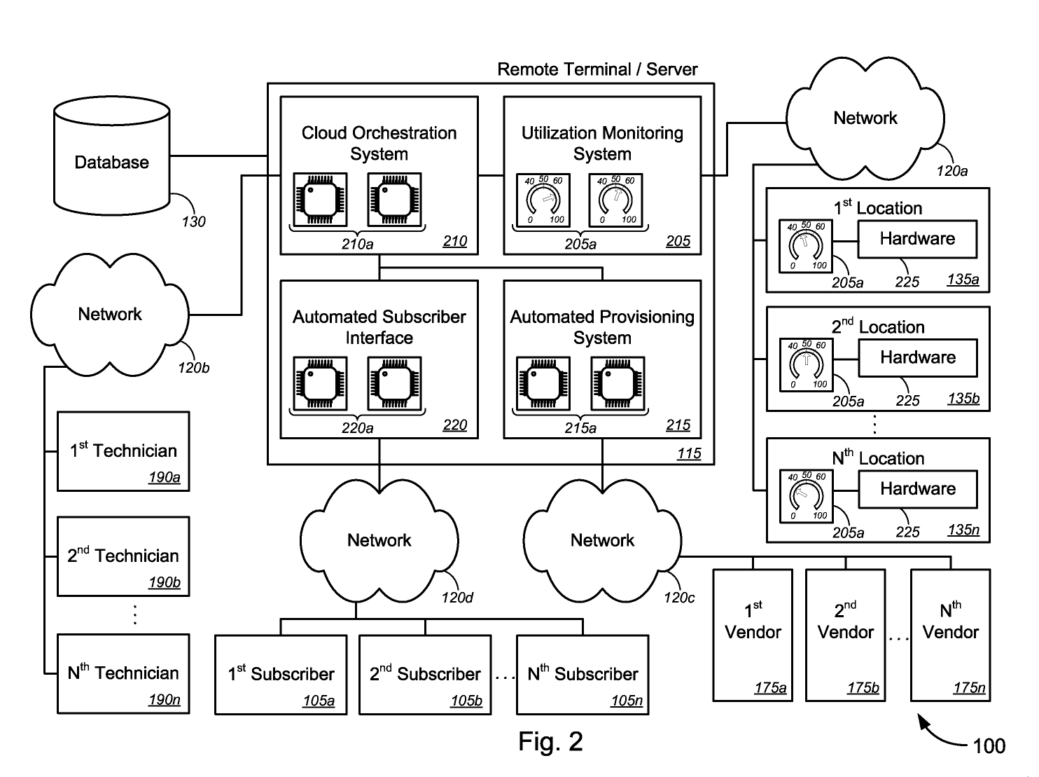

With reference to the figures, FIGS. 1 and 2 are general schematic diagrams illustrating a system 100 for implementing automated cloud expansion and ordering, in accordance with various embodiments. In FIG. 1, system 100 might comprise one or more subscribers 105, one or more user devices 110, remote terminal or server 115, network 120, one or more telecommunications relay systems 125, database 130, and/or one or more cloud service provider locations 135.

The one or more subscribers 105 might comprise a first subscriber 105a, a second subscriber 105b, through an N^{th} subscriber 105n. The one or more user devices 110 might be associated with the one or more subscribers 105, and might include, without limitation, a tablet computer 110a, a smart phone 110b, a laptop computer 110c, a desktop computer 110d, server computers 110e-110g, or any other suitable computing system, and the like. Although the first through N^{th} subscribers 105a-105n in FIG. 1 are shown associated with specific ones of the one or more user devices 110, the various embodiments are not so limited, and each subscriber 105 might be associated with any combination of the one or more user devices 110 described above.

The network 120 might include, but is not limited to, a cloud service provider network, a wide area network (“WAN”), the Internet, or other suitable network, and the like. The one or more telecommunications relay systems 125 might include, without limitation, one or more wireless network interfaces (e.g., wireless modems, wireless access points, and the like), one or more towers, or one or more satellites, and the like.

The one or more cloud service provider locations 135 might include a first location 135a, a second location 135b, through an N^{th} location 135n. Each of the first through N^{th} locations 135a-135n might be any suitable location at which a cloud service provider might install hardware for providing cloud services. The hardware might include, without limitation, one or more blade server systems 140, one or more rack server systems 145, one or more blade servers 150a-150b, one or more rack servers 150c, one or more server computers (or stand-alone servers) 155, one or more cooling systems 160, one or more data storage devices 165, one or more data storage drives 165a, one or more network devices 170, or the like.

Each of the one or more blade server systems 140 might comprise a chassis 140a having a plurality of server slots 140b (into which blade servers 150a-150b may be slotted) and a plurality of fan slots 140c (into which fan modules 160c may be slotted). The chassis 140a might comprise one or more power supplies (not shown) to provide power to all electronic components mounted in the chassis—including, but not limited to, blade servers 150a-150b, fan modules 160c, network devices 170, server management systems (not shown), or the like. In some cases, the slots 140b and 140c might be multipurpose slots that are configured to fit any of the electronic and other components described above, in any appropriate orientation and order. The chassis 140a might have an overall slot space that has a height measured in number of rack units (“RU” or “U”), which are standardized height measurements for blade server systems, with 1 RU being about 1.75 inches (or ˜4.45 cm) in height. In some cases, a half-height blade server 150a might have a height of about 4 RUs, while a full-height blade server 150b might have a height of about 8 RUs. A fan module 160c might have a height ranging from 1.5 RUs to 4 RUs. Chassis 140a might have different sizes ranging from 6 to 42 RU slot spacings. In terms of horizontal arrangement, an RU, according to some embodiments, might additional refer to a standardized width of about 19 inches (or ˜48 cm), while in other embodiments chassis 140a might have horizontal slot spacings (or width) to fit blade servers 150a-150b in multiples of 4, 5, or 6 side-by-side within each “row” of the server slots 140b. For example, FIG. 1 shows 12 blade servers 150a-150b fitted side-by-side within a single row of the server slots 140b.

In some cases, the one or more blade servers 150a-150b might be configured to be hot-swappable, and might each include one or more processors, one or more of input/output (“I/O”) cards, hard-drives, memory, multi-function network interconnects, network cards, or the like. Although FIG. 1 shows each of half-height blade servers 150a or full-height blade servers 150b as being the same type of blade servers, respectively, the various embodiments are not so limited, and allow for any type of blades, including, without limitation, multipurpose server blades, tape drive blades, data storage blades, virtual connect Ethernet modules, fiber channel passthrough modules, switch modules, enclosure interlink ports (to link and manage servers in multiple chassis), and/or blanking plates (for empty slots, to maintain efficiency of the cooling systems), or the like.

Each of the one or more rack server systems 145 might comprise a rack 145a having a plurality of slots 145b into which rack servers 150c may be slotted. Unlike blade servers—which are stripped down servers that share power supplies, fan modules, network devices, and the like with each other (or have common power supplies, fan modules, network devices, and the like for every set of two or more blade servers)—each rack server 150c might have built-in power supplies, fan modules, network devices, and the like. Rack servers 150c might otherwise function in a similar manner as blade servers 150a-150b.

In addition to fan modules 150c (for blade servers) or built-in fan modules (for rack servers), external cooling systems, such as the one or more cooling systems 160, may be used to ensure operating temperatures are maintained at optimal levels. The one or more cooling systems 160 might comprise at least one of liquid nitrogen (“LN₂”) systems 160a, water-based (“H₂O”) systems 160b, or fan systems 160c, and the like. These systems might be mounted to an exterior of the server enclosure (e.g., chassis 140a or rack 145a), might have conduits routed through the server enclosure, and/or might have conduits thermally connected with an exterior or interior surface(s) of the server enclosure, and the like.

The one or more data storage devices 165 might each comprise a plurality of drive slots 165b into which the data storage drives 165a may be slotted. Each data storage drive 165a might have a storage capacity of at least 1 TB, preferably at least 4 TB, and more preferably at least 6 TB.

System 100 might further comprise one or more vendors 175 and one or more technicians 190. The one or more vendors 175 might comprise a first vendor 175a, a second vendor 175b, through an N^{th} vendor 175n. Each of the one or more vendors 175 might sell any combination of cloud service, computing, and/or network hardware and equipment (not necessarily as specifically shown in the illustrative example in FIG. 1), including, but not limited to, blade server systems 140, rack server systems 145, blade servers 150a-150b, rack servers 150c, server computers (or stand-alone servers) 155, cooling systems 160, data storage devices 165, data storage drives 165a, network devices 170, as well as software 180 and accessories 185 for any of these components (as appropriate), or the like. According to some embodiments, software 180 might include, but is not limited to, operating system(s), necessary software applications, system configurations, and/or server/network configurations, and the like. In some cases, accessories 185 might include, without limitation, network cables 185a, power cables, data transfer cables, power adapters, power bars, data transfer adapters, connectors, blanking plates, tools for installing the hardware or equipment, testing kits for testing the hardware or equipment, pipes and hoses for the cooling systems, or other suitable devices or systems that might be useful for installing, maintaining, and/or testing the hardware or equipment for cloud services.

The one or more technicians 190 might comprise a first technician 190a, a second technician 190b, through an N^{th} technician 190n. Each technician might be associated with any combination of technician user devices 195 (not limited to the specific combination of technician user devices 195 shown in FIG. 1), which might include, without limitation, a tablet computer 195a-195c, a smart phone 195d-195f, and/or a mobile phone 195g-195i, and/or other suitable user devices (e.g., laptop computers, desktop computers, customized technician's hand-held devices, etc.).

With reference to FIG. 2, system 100 might further comprise a utilization monitoring system 205, a cloud orchestration system 210, an automated provisioning system 215, and/or an automated subscriber interface 220, any or all of which might be fully embodied at remote terminal 115 or one of the first through N^{th} locations 135a-135n, or partially embodied at two or more of remote terminal 115 or at least one of the first through N^{th} locations 135a-135n.

The utilization monitoring system 205 might comprise one or more utilization monitoring devices 205a, which are shown in a non-limiting example as being embodied at remote terminal 115 and each of the first through N^{th} locations 135a-135n. The one or more utilization monitoring devices 205a, however, might be embodied anywhere between remote terminal 115 and any of the first through N^{th} locations 135a-135n. Each of the one or more utilization monitoring devices 205a might be configured to monitor status and use of each of a plurality of hardware (including, but not limited to, blade server systems 140, rack server systems 145, blade servers 150a-150b, rack servers 150c, server computers (or stand-alone servers) 155, cooling systems 160, data storage devices 165, data storage drives 165a, or network devices 170, and the like) associated with cloud services provided by a cloud service provider. In some instances, at least one of the one or more utilization monitoring devices 205a (for example, but not limited to, a utilization monitoring device 205a located at remote terminal 115) might be configured to determine whether utilization of the plurality of hardware is likely to exceed a predetermined threshold, based on one of information related to new orders for cloud services by subscribers or a trend of the monitored status and use of each of the plurality of hardware. In some embodiments, the predetermined threshold might be 40%, 50%, 60%, 70%, 75%, or 80% utilization.

The cloud orchestration system 210 might comprise one or more first processors 210a, which are shown in a non-limiting example as being embodied only at remote terminal 115 (but can additionally, or alternatively, be located at one or more of the first through N^{th} locations 135a-135n). The one or more first processors 210a might be configured to, based on a determination (e.g., by the one or more utilization monitoring devices 205a) that utilization of the plurality of hardware is likely to exceed a predetermined threshold (including, but not limited to, 40, 50, 60, 70, 75, or 80% utilization), determine a number of new equipment and a type of each of the new equipment to purchase in order to ensure that utilization of a combination of the plurality of hardware and the new equipment does not exceed the predetermined threshold. The one or more first processors 210a might be further configured to determine location information for installation of each of the new equipment. Each of the location information might comprise geographic location information (e.g., address and/or global positioning system (“GPS”) coordinates) for one or more of the first through N^{th} locations 135a-135n, rack information (e.g., rack or chassis identification (“ID”) number and/or rack or chassis location at a subject one of the first through N^{th} locations 135a-135n), and/or slot information (e.g., slot ID number and/or slot location of the subject rack or chassis) corresponding to installation of each of the new equipment.

The automated provisioning system 215 might comprise one or more second processors 215a, which are shown in a non-limiting example as being embodied only at remote terminal 115 (but can additionally, or alternatively, be located at one or more of the first through N^{th} locations 135a-135n). The one or more second processors 215a might be configured to generate one or more purchase orders for the new equipment to be sent to the one or more equipment vendors 175a-175n, based on the determined number of new equipment and the type of each of the new equipment. The one or more second processors 215a might be further configured to send the one or more purchase orders to the one or more equipment vendors 175a-175n. In some cases, the one or more second processors 215a might also be configured to add the determined location information in the one or more purchase orders, either prior to sending the purchase orders to the one or more equipment vendors 175a-175n, or as an amendment or corrected purchase order(s) after sending the purchase orders to the one or more equipment vendors 175a-175n.

The automated subscriber system 220 might comprise one or more third processors 220a, which are shown in a non-limiting example as being embodied only at remote terminal 115 (but can additionally, or alternatively, be located at one or more of the first through N^{th} locations 135a-135n). The one or more third processors 220a might be configured to receive, over a network, an order from a subscriber (e.g., one of the first through N^{th} subscribers 105a-105n) for new cloud services.

According to some embodiments, the one or more second processors 215a might be further configured to receive equipment information and shipment tracking information from each of the one or more equipment vendors 175a-175n. The one or more first processors 210a might be further configured to generate a first set of work orders comprising equipment information, shipment tracking information, geographic location information, rack information, and slot information for each of the new equipment, and to send the first set of work orders to one or more technicians 190a-190n for installing each of the new equipment at the determined geographic location (i.e., at one of the first through N^{th} locations 135a-135n) corresponding to the subject new equipment.

In some embodiments, the one or more first processors 210a might be further configured to determine one or more software applications (including, without limitation, operating system(s), necessary software applications, system configurations, and/or server/network configurations, etc.) for installation on each of the new equipment. Based on a determination that one or more of the new equipment have been installed and that the one or more of the new equipment are accessible over the network, the one or more first processors 210a might be configured to install, over a network (e.g., network 120a), the one or more software applications on each of the one or more of the new equipment. Based on a determination that at least one of the new equipment has been installed and that the at least one of the new equipment is inaccessible over the network, the one or more first processors 210a might be configured to send, over a network (e.g., network 120b), the one or more software applications for each of the at least one of the new equipment to one or more technicians 190a-190n, and to send a second set of work orders to the one or more technicians 190a-190n to manually install the one or more software applications on each of the at least one of the new equipment. Although networks 120a, 120b, 120c, and 120d are shown as separate networks, each communicatively coupled to one of the utilization monitoring system 205, the cloud orchestration system 210, the automated provisioning system 215, the automated subscriber interface 220, respectively, two, more, or all of networks 120a, 120b, 120c, and 120d may be the same network. For example, FIG. 1 shows these networks as a single network 120.

In operation, one of at least three events might trigger monitoring of the utilization of hardware associated with the cloud services provided by the cloud service provider. A first event might be receiving, at the remote terminal 115 (e.g., at the automated subscriber interface 220), an order for new cloud services from user device 110 of one of the first through N^{th} subscribers 105a-105n via network 120 (and, in some cases, also via the one or more telecommunications relays systems 125). A second event might be receiving, at the remote terminal 115 (e.g., at the automated subscriber interface 220), one or more complaints pertaining to existing cloud services (e.g., decreased speed of cloud services, cloud service overloads or shutdowns, errors, or the like) from user device 110 of one of the first through N^{th} subscribers 105a-105n via network 120 (and, in some cases, also via the one or more telecommunications relays systems 125). A third event might be a periodically scheduled trigger established by the cloud service provider to begin monitoring the hardware utilization; in some cases, the triggers might be scheduled for one or more of every hour, every few hours, every half day, every day, every other day, three times a week, twice a week, every week, every other week, every month, every other month, every quarter, every half year, every year, etc. In addition, or in the alternative, a passive monitoring of hardware utilization might be implemented, where exceeding the predetermined threshold (e.g., 40, 50, 60, 70, 75, or 80% utilization) might trigger an active monitoring of the utilization of the hardware associated with the cloud services provided by the cloud service provider.

Once hardware utilization monitoring has been initiated (e.g., by utilization monitoring system 205), remote terminal 115 (and in some cases, utilization monitoring system 205 specifically) might determine whether the hardware utilization might exceed a predetermined threshold (e.g., 40, 50, 60, 70, 75, or 80% utilization). In the case of a new order for cloud services being the trigger, such a determination might be based on current hardware utilization in addition to an estimated utilization in light of the new cloud services being ordered. Such estimated utilization might be based at least in part on example or known hardware utilization of similarly situated subscribers who have ordered similar cloud services (which may, in some cases, be extrapolated or interpolated where scales of operation might differ between those of the current subscriber and those of the similarly situated subscribers). In the case of complaints being the trigger, such a determination might be based on current hardware utilization alone. In the case of periodically scheduled triggers, such a determination might be based on a trend of the monitored status and use of each of the plurality of hardware (which includes the current hardware utilization and previously stored hardware utilization).

If it is determined that the hardware utilization might exceed (or has exceeded) a predetermined threshold value (e.g., 40, 50, 60, 70, 75, or 80% utilization), the remote terminal 115 (and in some cases, the cloud orchestration system 210 in particular) might determine a number (and type) of new equipment to purchase to ensure that the hardware utilization of the existing and new hardware or equipment does not exceed the predetermined threshold. In some cases, the remote terminal 115 (or the cloud orchestration system 210, in particular) might determine location information for installation of each of the new equipment. This might be based on a number of factors for optimizing cloud services. Such factors might include geographic location considerations of the subscriber of the new cloud services; the costs of electricity in certain geographic locations (for powering the hardware for the existing and new cloud services); the tax considerations (based on geographic location) for purchasing the new equipment or hardware; network load balancing; proximity of certain ones of the first through N^{th} locations 135a-135n to telecommunications core/backbone networks, trunk lines, and/or high-speed transmission lines; or the like. As discussed above, the location information might comprise geographic location information (e.g., address and/or global positioning system (“GPS”) coordinates; site location information; etc.) for one or more of the first through N^{th} locations 135a-135n, rack information (e.g., rack or chassis identification (“ID”) number and/or rack or chassis location at a subject one of the first through N^{th} locations 135a-135n), and/or slot information (e.g., slot ID number and/or slot location of the subject rack or chassis) corresponding to installation of each of the new equipment.

Based on the determined number (and type) of new equipment, the remote terminal 115 (and in some cases, the automated provisioning system 210 in particular) might generate one or more purchase orders for the new equipment, and might send the purchase orders to the one or more equipment vendors 175a-175n. In some cases, the remote terminal 115 (or the automated provisioning system 210, in particular) might add the determined location information in the one or more purchase orders (either prior to sending the purchase orders to the vendors 175 or as a corrected or replacement purchase order if already sent).

In some cases, the remote terminal 115 (and in some cases, the automated provisioning system 210 in particular) might receive equipment information and shipment tracking information from each of the one or more equipment vendors 175a-175n. The remote terminal 115 (or the cloud orchestration system, in particular) might generate and send a first set of work orders to one or more technicians 190 for installing each of the new equipment at appropriate ones of the first through N^{th} locations 135a-135n. The first set of work orders might include order information—which might specify equipment information (e.g., equipment identification number, such as serial number or the like; model number; manufacturer; product details; etc.), shipment tracking information, or both—and location information—which might specify one or more of geographic location information (e.g., coordinates or site location information), rack information, and/or slot information for installation of each of the new equipment.

According to some embodiments, the remote terminal 115 (or the cloud orchestration system, in particular) might determine which of one or more software applications might be necessary or appropriate for installation on each of the new equipment. Based on a determination that one or more of the new equipment have been installed and are accessible over a network (e.g., network 120), the remote terminal 115 (or the cloud orchestration system, in particular) might automatically install (over the network) the one or more software applications (including, without limitation, operating system(s), necessary software applications, system configurations, and/or server/network configurations, etc.) on each of the one or more of the new equipment. On the other hand, based on a determination that at least one of the new equipment has been installed but is inaccessible over the network (e.g., network 120 or other suitable network), the remote terminal 115 (or the cloud orchestration system, in particular) might send (over the network 120) the one or more software applications for each of the at least one of the new equipment to the one or more technicians 190, while concurrently (or sequentially) sending a second work order to the one or more technicians to manually install the one or more software applications on each of the at least one of the new equipment. In some instances, the first and second work orders might be sent to the same technician 190, who might wait at least long enough for the remote terminal 115 to make one or more attempts at accessing the newly installed equipment over the network, prior to leaving the site (i.e., the subject location 135). After the access attempts have failed, the remote terminal 115 might send the software application(s) to the technician's user device 195, so that the technician 190 can immediately manually install the software application(s) on the network inaccessible newly installed equipment, as well as to troubleshoot (with suggestions from the remote terminal 115) the new equipment to enable network access to the new equipment.

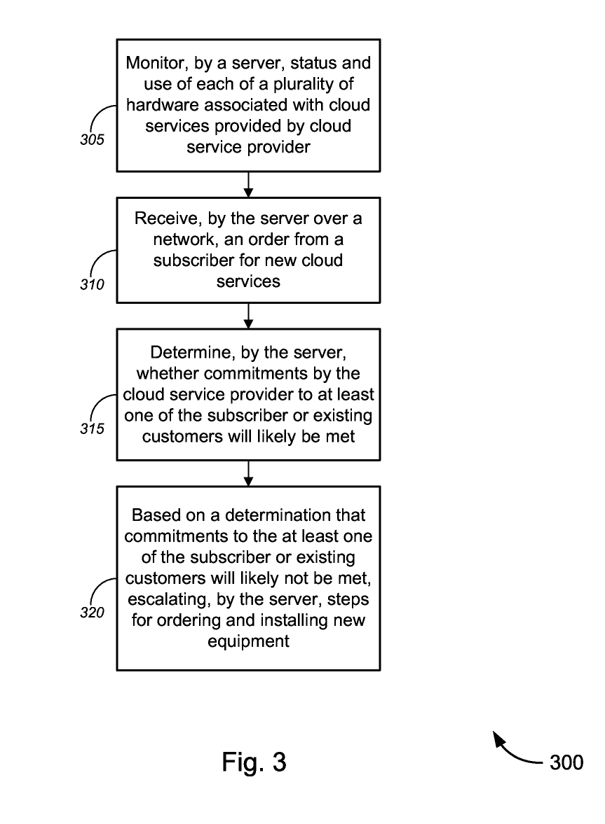

We now turn to FIGS. 3-5, which are general schematic flow diagrams illustrating methods 300-500 for implementing automated cloud expansion and ordering, in accordance with various embodiments. In FIGS. 3-5, methods 300, 400, and 500 might be combinable with each other, or might be implemented separately. Various process blocks in each of methods 300, 400, and 500 may be optional or re-ordered within the subject method, or interchangeable with other blocks (as appropriate) in another of methods 300, 400, and 500.

With reference to FIG. 3, method 300 might comprise, at block 305, monitoring, by a server (e.g., remote terminal 115 shown in FIGS. 1 and 2), status and use of each of a plurality of hardware (including, but not limited to, blade server systems 140, rack server systems 145, blade servers 150a-150b, rack servers 150c, server computers (or stand-alone servers) 155, cooling systems 160, data storage devices 165, data storage drives 165a, or network devices 170, and the like) associated with cloud services provided by a cloud service provider. At block 310, method 300 might comprise receiving, by the server (and over a network), an order from a subscriber for new cloud services. The subscriber can be an existing subscriber or a new customer. The method might further comprise determining, by the server, whether commitments by the cloud service provider to at least one of the subscriber or existing customers are being met or will likely be met (block 315). At block 320, method 300 might comprise, based on a determination that commitments to the at least one of the subscriber or existing customers are not being met or will not likely be met, escalating, by the server, steps for ordering and installing new equipment.

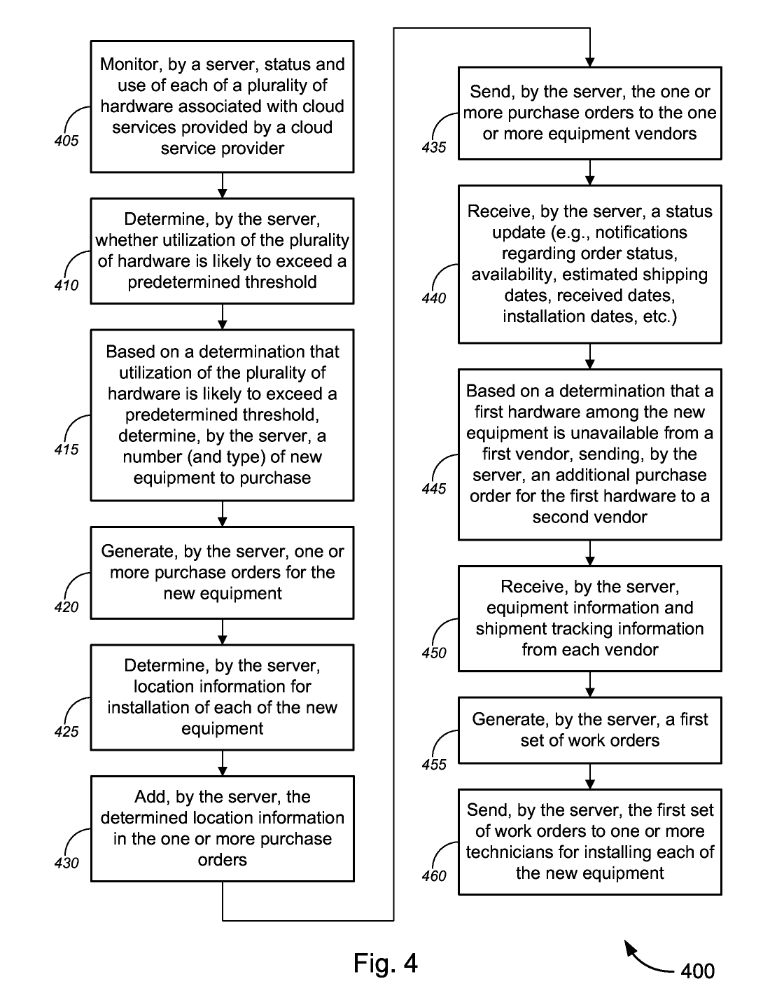

In FIG. 4, method 400 might comprise monitoring, by a server (e.g., remote terminal 115 shown in FIGS. 1 and 2), status and use of each of a plurality of hardware (including, but not limited to, blade server systems 140, rack server systems 145, blade servers 150a-150b, rack servers 150c, server computers (or stand-alone servers) 155, cooling systems 160, data storage devices 165, data storage drives 165a, or network devices 170, and the like) associated with cloud services provided by a cloud service provider (block 405). At block 410, method 400 might comprise determining, by the server, whether utilization of the plurality of hardware is likely to exceed a predetermined threshold (e.g., 40, 50, 60, 70, 75, or 80% utilization). Method 400, at block 415, might comprise—based on a determination that utilization of the plurality of hardware is likely to exceed a predetermined threshold—determining, by the server a number (and type) of new equipment to purchase, in order to ensure that utilization of a combination of the plurality of hardware and new equipment does not exceed the predetermined threshold.

At block 420, method 400 might comprise generating, by the server, one or more purchase orders for the new equipment, based on the determined number (and type) of new equipment. Method 400 might further comprise determining, by the server, location information (including, but not limited to, geographic location information, rack information, and/or slot information) for installation of each of the new equipment (block 425). Method 400, at block 430, might comprise adding, by the server, the determined location information in the one or more purchase orders. At block 435, method 400 might comprise sending, by the server, the one or more purchase orders to the one or more equipment vendors (e.g., vendors 175a-175n).

Method 400 might further comprise, at block 440, receiving, by the server, a status update (which might include, without limitation, at least one of a notification that the new equipment has been ordered, a notification regarding availability of the new equipment by the one or more equipment vendors, one or more shipping dates of the new equipment, one or more received dates of the new equipment, or one or more installation dates of the new equipment, and the like). In some cases, the status update might further include, but is not limited to, a notification regarding successful installation of software applications, a notification regarding unsuccessful installation of software applications, a notification regarding successful network integration of one or more of the new equipment, a notification regarding unsuccessful network integration of one or more of the new equipment, or the like.

At block 445, based on a determination that a first hardware among the new equipment is unavailable from a first vendor (e.g., vender 175a), method 400 might comprise sending, by the server, an additional purchase order for the first hardware to a second vendor (e.g., vender 175b). Method 400 might further comprise, at block 450, receiving, by the server, equipment information and shipment tracking information from each vendor. Method 400 might also comprise generating, by the server, a first set of work orders (which, in some cases, might comprise one or more of equipment information, shipment tracking information, geographic location information, rack information, and/or slot information for each of the new equipment) (block 455). At block 460, method 400 might comprise sending, by the server, the first set of work orders to one or more technicians for installing each of the new equipment at the determined geographic location corresponding to the subject new equipment.

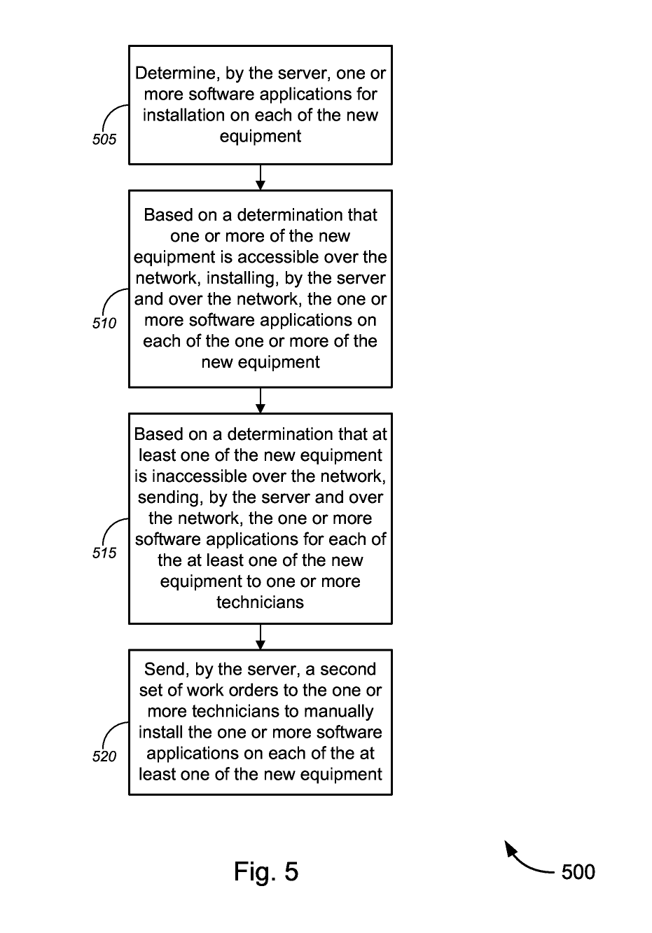

Turning to FIG. 5, method 500 might comprise, at block 505, determining, by the server, one or more software applications for installation on each of the new equipment. At block 510, method 500 might comprise (based on a determination that one or more of the new equipment have been installed and are accessible over the network) installing, by the server and over the network, the one or more software applications for on each of the one or more of the new equipment. Method 500 might further comprise, based on a determination that at least one of the new equipment has been installed but is inaccessible over the network (or any network), sending, by the server and over the network, the one or more software applications for each of the at least one of the new equipment to one or more technicians (e.g., technicians 190), and more specifically to one or more the user devices associated with the one or more technicians (e.g., one or more technician user devices 195). At block 520, method 500 might comprise sending, by the server, a second set of work orders to the one or more technicians to manually install the one or more software applications on each of the at least one of the new equipment.

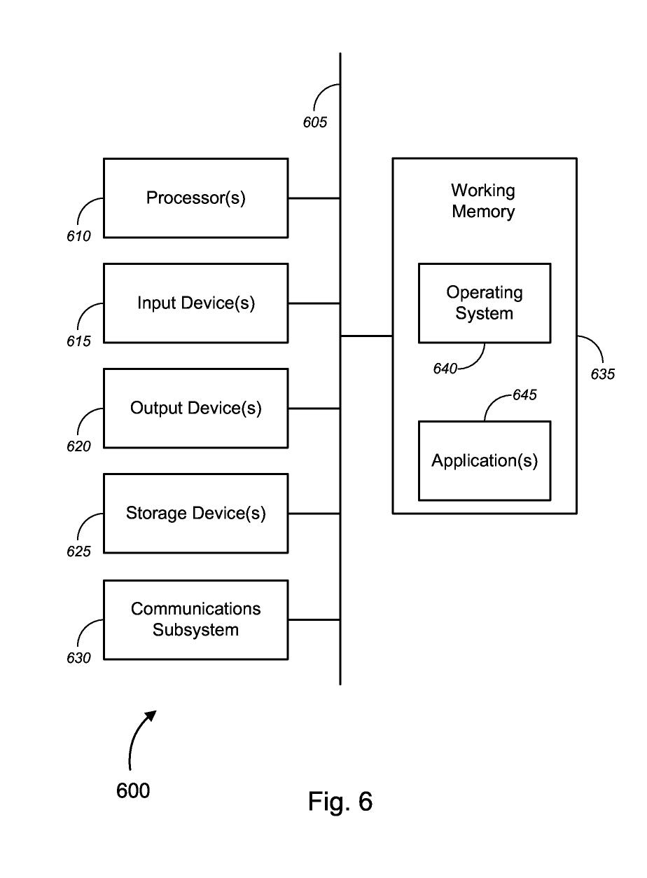

We now turn to FIG. 6, which is a block diagram illustrating an exemplary computer architecture. FIG. 6 provides a schematic illustration of one embodiment of a computer system 600 that can perform the methods provided by various other embodiments, as described herein, and/or can perform the functions of local computer system 110 or 195, or remote computer system 115, cloud computing system 140 or 145, or other computer systems as described above. It should be noted that FIG. 6 is meant only to provide a generalized illustration of various components, of which one or more, or none, of each may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605, or may otherwise be in communication, as appropriate. The hardware elements may include one or more processors 610, including without limitation one or more general-purpose processors, or one or more special-purpose processors such as digital signal processing chips, graphics acceleration processors, or the like; one or more input devices 615, which can include without limitation a mouse, a keyboard, or the like; and one or more output devices 620, which can include without limitation a display device, a printer, or the like.

The computer system 600 may further include, or be in communication with, one or more storage devices 625. The one or more storage devices 625 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including without limitation various file systems, database structures, or the like.

The computer system 600 might also include a communications subsystem 630, which can include without limitation a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 630 may permit data to be exchanged with a network (such as network 120, to name an example), with other computer systems, with any other devices described herein, or with any combination of network, systems, and devices. According to some embodiments, network 120 (including networks 120a-120d) might include a local area network (“LAN”), including without limitation a fiber network, an Ethernet network, a Token-Ring™ network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol, or any other wireless protocol; or any combination of these or other networks. In many embodiments, the computer system 600 will further comprise a working memory 635, which can include a RAM or ROM device, as described above.

The computer system 600 may also comprise software elements, shown as being currently located within the working memory 635, including an operating system 640, device drivers, executable libraries, or other code. The software elements may include one or more application programs 645, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 625 described above. In some cases, the storage medium might be incorporated within a computer system, such as the system 600. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 600, or might take the form of source or installable code. The source or installable code, upon compilation, installation, or both compilation and installation, on the computer system 600 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 600, to perform methods in accordance with various embodiments of the invention. According to a set of embodiments, some or all of the procedures of such methods might be performed by the computer system 600 in response to processor 610 executing one or more sequences of one or more instructions. The one or more instructions might be incorporated into the operating system 640 or other code that may be contained in the working memory 635, such as an application program 645. Such instructions may be read into the working memory 635 from another computer readable medium, such as one or more of the storage devices 625. Merely by way of example, execution of the sequences of instructions contained in the working memory 635 might cause the one or more processors 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 600, various computer readable media might be involved in providing instructions or code to the one or more processors 610 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 625. Volatile media includes, without limitation, dynamic memory, such as the working memory 635. Transmission media includes, without limitation, coaxial cables, copper wire and fiber optics, including the wires that comprise the bus 605, as well as the various components of the communication subsystem 630, or the media by which the communications subsystem 630 provides communication with other devices. Hence, transmission media can also take the form of waves, including without limitation radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

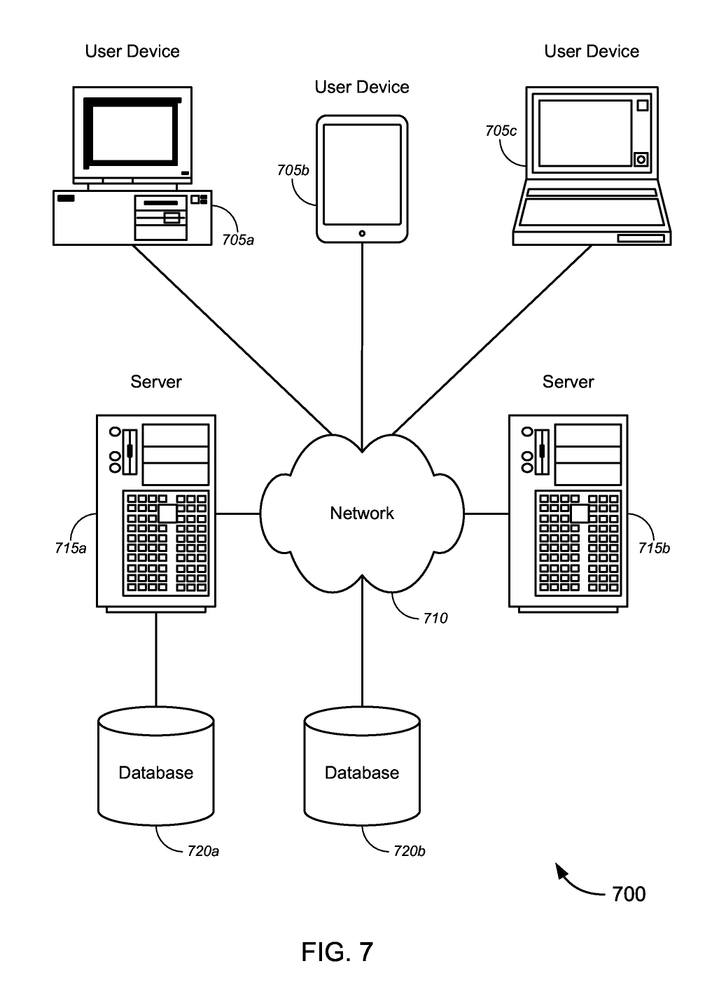

As noted above, a set of embodiments comprises methods and systems for implementing automated cloud expansion and ordering. FIG. 7 illustrates a schematic diagram of a system 700 that can be used in accordance with one set of embodiments. The system 700 can include one or more user computers or user devices 705. A user computer or user device 705 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 705 can also have any of a variety of applications, including one or more applications configured to perform methods provided by various embodiments (as described above, for example), as well as one or more office applications, database client and/or server applications, and/or web browser applications. Alternatively, a user computer or user device 705 can be any other electronic device, such as a thin-client computer, Internet-enabled mobile telephone, and/or personal digital assistant, capable of communicating via a network (e.g., the network 710 described below) and/or of displaying and navigating web pages or other types of electronic documents. Although the exemplary system 700 is shown with three user computers or user devices 705, any number of user computers or user devices can be supported.

Certain embodiments operate in a networked environment, which can include a network 710. The network 710 can be any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network 710 can include a local area network (“LAN”), including without limitation a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 715. Each of the server computers 715 may be configured with an operating system, including without limitation any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 might be a data server, as described above. The data server might include (or be in communication with) a web server, which can be used, merely by way of example, to process requests for web pages or other electronic documents from user computers 705. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform methods of the invention.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer or user device 705 and/or another server 715. In some embodiments, an application server can perform one or more of the processes for implementing automated cloud expansion and ordering, or the like, as described in detail above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer or user device 705 and/or server 715.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720. The location of the database(s) 720 is discretionary: merely by way of example, a database 720a might reside on a storage medium local to (and/or resident in) a server 715a (and/or a user computer or user device 705). Alternatively, a database 720b can be remote from any or all of the computers 705, 715, so long as it can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method for implementing automated cloud expansion and ordering, the method comprising:
receiving, at a server associated with a cloud service provider and over a network, an order from a subscriber for new cloud services;
monitoring, by the server, status and use of each of a plurality of hardware associated with cloud services provided by the cloud service provider;
determining, by the server, whether addition of the new cloud services ordered by the subscriber is likely to cause utilization of the plurality of hardware to exceed a predetermined threshold;
based on a determination that addition of the new cloud services ordered by the subscriber is likely to cause utilization of the plurality of hardware to exceed a predetermined threshold, determining, by the server, a number of new equipment and a type of each of the new equipment to purchase in order to ensure that the cloud services including the new cloud services does not cause utilization of a combination of the plurality of hardware and the new equipment to exceed the predetermined threshold;
generating, by the server, one or more purchase orders for the new equipment to be sent to one or more equipment vendors, based on the determined number of new equipment and the type of each of the new equipment;
determining, by the server, geographic location information, rack information, and slot information for installation of each of the new equipment;
adding, by the server, the determined geographic location information, rack information, and slot information for each of the new equipment in the one or more purchase orders;
sending, by the server, the one or more purchase orders to the one or more equipment vendors;
receiving, by the server, equipment information and shipment tracking information from each of the one or more equipment vendors;
generating, by the server, a first set of work orders comprising equipment information, shipment tracking information, geographic location information, rack information, and slot information for each of the new equipment;
sending, by the server, the first set of work orders to one or more technicians for installing each of the new equipment at the determined geographic location corresponding to the subject new equipment;
determining, by the server, one or more software applications for installation on each of the new equipment;
based on a determination that one or more of the new equipment have been installed by the one or more technicians and that the one or more of the new equipment are accessible over the network, installing, by the server and over the network, the one or more software applications on each of the one or more of the new equipment;
based on a determination that at least one of the new equipment has been installed by the one or more technicians and that the at least one of the new equipment is inaccessible over the network, sending, by the server and over the network, the one or more software applications for each of the at least one of the new equipment to the one or more technicians and sending a second set of work orders to the one or more technicians to manually install the one or more software applications on each of the at least one of the new equipment.

2. A method for implementing automated cloud expansion and ordering, the method comprising:
monitoring, by a server associated with a cloud service provider, status and use of each of a plurality of hardware associated with cloud services provided by the cloud service provider;
determining, by the server, whether utilization of the plurality of hardware is likely to exceed a predetermined threshold, based on one of a trend of the monitored status and use of each of the plurality of hardware or information related to new orders for cloud services by subscribers;
based on a determination that utilization of the plurality of hardware is likely to exceed a predetermined threshold, determining, by the server, a number of new equipment and a type of each of the new equipment to purchase in order to ensure that utilization of a combination of the plurality of hardware and the new equipment does not exceed the predetermined threshold;
generating, by the server, one or more purchase orders for the new equipment to be sent to one or more equipment vendors, based on the determined number of new equipment and the type of each of the new equipment;
determining, by the server, location information for installation of each of the new equipment;
adding, by the server, the determined location information in the one or more purchase orders;
sending, by the server, the one or more purchase orders to the one or more equipment vendors.

3. The method of claim 2, further comprising:
receiving, by the server over a network, an order from a subscriber for new cloud services.

4. The method of claim 3, further comprising:
determining, by the server, whether commitments by the cloud service provider to at least one of the subscriber or existing customers will likely be met;
based on a determination that commitments to the at least one of the subscriber or the existing customers will likely not be met, escalating, by the server, steps for ordering and installing the new equipment.

5. The method of claim 2, wherein the predetermined threshold comprises percentage utilization selected from a group consisting of 50 percent, 60 percent, 70 percent, 75 percent, and 80 percent.

6. The method of claim 2, wherein each of the location information comprises geographic location information, rack information, and slot information corresponding to installation of each of the new equipment.

7. The method of claim 6, further comprising:
receiving, by the server, equipment information and shipment tracking information from each of the one or more equipment vendors;
generating, by the server, a first set of work orders comprising equipment information, shipment tracking information, geographic location information, rack information, and slot information for each of the new equipment;
sending, by the server, the first set of work orders to one or more technicians for installing each of the new equipment at the determined geographic location corresponding to the subject new equipment.

8. The method of claim 2, further comprising:
determining, by the server, one or more software applications for installation on each of the new equipment;
based on a determination that one or more of the new equipment have been installed and that the one or more of the new equipment are accessible over the network, installing, by the server and over the network, the one or more software applications on each of the one or more of the new equipment;
based on a determination that at least one of the new equipment has been installed and that the at least one of the new equipment is inaccessible over the network, sending, by the server and over the network, the one or more software applications for each of the at least one of the new equipment to one or more technicians and sending a second set of work orders to the one or more technicians to manually install the one or more software applications on each of the at least one of the new equipment.

9. The method of claim 2, wherein the new equipment includes cloud service equipment selected from a group consisting of servers, blade servers, data storage devices, network devices, cooling systems, and equipment racks.

10. The method of claim 2, further comprising:
receiving, by the server, a status update comprising at least one of a notification that the new equipment has been ordered, a notification regarding availability of the new equipment by the one or more equipment vendors, one or more shipping dates of the new equipment, one or more received dates of the new equipment, or one or more installation dates of the new equipment; and
based on a determination that a first hardware among the new equipment is unavailable from a first vendor of the one or more equipment vendors, sending, by the server, an additional purchase order for the first hardware to a second vendor of the one or more equipment vendors.

11. An apparatus for implementing automated cloud expansion and ordering, the apparatus comprising:
one or more processors;
one or more non-transitory computer readable media having stored thereon software comprising a set of instructions that, when executed by the one or more processors, causes the apparatus to perform one or more functions, the set of instructions comprising:
instructions to monitor status and use of each of a plurality of hardware associated with cloud services provided by a cloud service provider;
instructions to determine whether utilization of the plurality of hardware is likely to exceed a predetermined threshold, based on one of a trend of the monitored status and use of each of the plurality of hardware or information related to new orders for cloud services by subscribers;
instructions to determine, based on a determination that utilization of the plurality of hardware is likely to exceed a predetermined threshold, a number of new equipment and a type of each of the new equipment to purchase in order to ensure that utilization of a combination of the plurality of hardware and the new equipment does not exceed the predetermined threshold;
instructions to generate one or more purchase orders for the new equipment to be sent to one or more equipment vendors, based on the determined number of new equipment and the type of each of the new equipment;
instructions to determine location information for installation of each of the new equipment;
instructions to add the determined location information in the one or more purchase orders; and
instructions to send the one or more purchase orders to the one or more equipment vendors.

12. The apparatus of claim 11, wherein the set of instructions further comprises:
instructions to receive, over a network, an order from a subscriber for new cloud services.

13. The apparatus of claim 12, wherein the set of instructions further comprises:
instructions to determine whether commitments by the cloud service provider to at least one of the subscriber and existing customers will likely be met; and
instructions to, based on a determination that commitments to the at least one of the subscriber and the existing customers will likely not be met, escalate steps for ordering and installing the new equipment.

14. The apparatus of claim 11, wherein the predetermined threshold comprises percentage utilization selected from a group consisting of 50 percent, 60 percent, 70 percent, 75 percent, and 80 percent.

15. The apparatus of claim 11, wherein each of the location information comprises geographic location information, rack information, and slot information corresponding to installation of each of the new equipment.

16. The apparatus of claim 15, wherein the set of instructions further comprises:
instructions to receive equipment information and shipment tracking information from each of the one or more equipment vendors;
instructions to generate a first set of work orders comprising equipment information, shipment tracking information, geographic location information, rack information, and slot information for each of the new equipment; and
instructions to send the first set of work orders to one or more technicians for installing each of the new equipment at the determined geographic location corresponding to the subject new equipment.

17. The apparatus of claim 11, wherein the set of instructions further comprises:
instructions to determine one or more software applications for installation on each of the new equipment;
instructions to, based on a determination that one or more of the new equipment have been installed and that the one or more of the new equipment are accessible over the network, install, over the network, the one or more software applications on each of the one or more of the new equipment; and
instructions to, based on a determination that at least one of the new equipment has been installed and that the at least one of the new equipment is inaccessible over the network, send, over the network, the one or more software applications for each of the at least one of the new equipment to one or more technicians, and send a second set of work orders to the one or more technicians to manually install the one or more software applications on each of the at least one of the new equipment.

18. The apparatus of claim 11, wherein the new equipment includes cloud service equipment selected from a group consisting of servers, blade servers, data storage devices, network devices, cooling systems, and equipment racks.

19. The apparatus of claim 11, wherein the set of instructions further comprises:
instructions to receive a status update comprising at least one of a notification that the new equipment has been ordered, a notification regarding availability of the new equipment by the one or more equipment vendors, one or more shipping dates of the new equipment, one or more received dates of the new equipment, or one or more installation dates of the new equipment; and
instructions to, based on a determination that a first hardware among the new equipment is unavailable from a first vendor of the one or more equipment vendors, send an additional purchase order for the first hardware to a second vendor of the one or more equipment vendors.

20. A system for implementing automated cloud expansion and ordering, the system comprising:
a utilization monitoring system comprising one or more utilization monitoring devices configured to:
monitor status and use of each of a plurality of hardware associated with cloud services provided by a cloud service provider; and
determine whether utilization of the plurality of hardware is likely to exceed a predetermined threshold, based on one of a trend of the monitored status and use of each of the plurality of hardware or information related to new orders for cloud services by subscribers;
a cloud orchestration system comprising one or more first processors configured to:
based on a determination that utilization of the plurality of hardware is likely to exceed a predetermined threshold, determine a number of new equipment and a type of each of the new equipment to purchase in order to ensure that utilization of a combination of the plurality of hardware and the new equipment does not exceed the predetermined threshold; and
determine location information for installation of each of the new equipment; and
an automated provisioning system comprising one or more second processors configured to:
generate one or more purchase orders for the new equipment to be sent to one or more equipment vendors, based on the determined number of new equipment and the type of each of the new equipment;
add the determined location information in the one or more purchase orders; and
send the one or more purchase orders to the one or more equipment vendors.

21. The system of claim 20, further comprising:
an automated subscriber interface system comprising one or more third processors configured to:
receive, over a network, an order from a subscriber for new cloud services.

22. The system of claim 20, wherein each of the location information comprises geographic location information, rack information, and slot information corresponding to installation of each of the new equipment.

23. The system of claim 22, wherein:
the one or more second processors of the automated provisioning system are further configured to:
receive equipment information and shipment tracking information from each of the one or more equipment vendors;
the one or more first processors of the cloud orchestration system are further configured to:
generate a first set of work orders comprising equipment information, shipment tracking information, geographic location information, rack information, and slot information for each of the new equipment; and
send the first set of work orders to one or more technicians for installing each of the new equipment at the determined geographic location corresponding to the subject new equipment.

24. The system of claim 20, wherein the one or more first processors of the cloud orchestration system are further configured to:
determine one or more software applications for installation on each of the new equipment;
based on a determination that one or more of the new equipment have been installed and that the one or more of the new equipment are accessible over the network, install, over the network, the one or more software applications on each of the one or more of the new equipment; and
based on a determination that at least one of the new equipment has been installed and that the at least one of the new equipment is inaccessible over the network, send, over the network, the one or more software applications for each of the at least one of the new equipment to one or more technicians, and send a second set of work orders to the one or more technicians to manually install the one or more software applications on each of the at least one of the new equipment.
